(19) United States
(12) Patent Application Publication
(10) Pub. No.: US 2022/0213922 A1
(43) Pub. Date: Jul. 7, 2022

(54) TIE BOLT AND PROCESS FOR MANUFACTURING A TIE BOLT

(71) Applicant: POGGIPOLINI S.P.A., SAN LAZZARO DI SAVENA (BO) (IT)

(72) Inventors: Stefano Poggipolini, SAN LAZZARO DI SAVENA (BO) (IT); Michele Poggipolini, SAN LAZZARO DI SAVENA (BO) (IT); Giancarlo Buoso, SAN LAZZARO DI SAVENA (BO) (IT); Simone Ravaglia, SAN LAZZARO DI SAVENA (BO) (IT)

(21) Appl. No.: 17/610,884

(22) PCT Filed: May 14, 2020
(86) PCT No.: PCT/IB2020/054584

§ 371 Date: Nov. 12, 2021

(30) Foreign Application Priority Data
May 14, 2019 (IT) 102019000006813

(51) Int. Cl. F16B 39/30; F16B 37/14; F16B 39/02

(52) U.S. Cl. CPC F16B 39/30; F16B 39/02; F16B 37/14

(57) ABSTRACT

Tie bolt and process for making such tie bolt having a shank and a nut, in particular a dead nut; wherein the nut is tightened and locked around a respective end of the shank, so as to form an indivisible body.

### CROSS-REFERENCE TO RELATED APPLICATIONS

This patent application claims priority from Italian patent application no. 102019000006813 filed on 14 May 2019, the entire disclosure of which is incorporated herein by reference.

### TECHNICAL FIELD

The present invention relates to a tie bolt and to a process for manufacturing such tie bolt.

In particular, the present invention relates to a tie bolt for automotive applications and a process for manufacturing a tie bolt of such type.

### BACKGROUND ART

A tie bolt of the known type is a single body having a shank and a head, which protrudes at one end of said shank. The shank is substantially a cylindrical body having a longitudinal axis of rotation, while the tie bolt head can have different shapes according to the specific use. Generally, the head protrudes both axially and radially outside the shank. In particular, a tie bolt has a length, i.e. an extension along the rotation axis, significantly greater than its diameter. As is known, a tie bolt can have a length greater than 150 mm. For example, in the case of automotive applications, a tie bolt can have a length greater than 200 mm, preferably about 300 mm.

In more detail, the present invention relates to a special tie bolt, i.e. a tie bolt made of a material lighter than steel, highly performing for automotive applications. In particular, the present invention relates to a tie bolt made of a material with high mechanical strength, for example made of titanium alloy.

In the common practice, different problems are encountered for manufacturing tie bolts.

In fact, generally the head of a tie bolt is made by forging, using automatic molding machines. However, the automatic molding machines generally in use are unable to make tie bolts having a shank of sufficient length for manufacturing a tie bolt. In this case, therefore, a molding machine other than the standard design should be provided, in order to be able to make the tie bolts. This can be conceived mainly for tie bolts made of steel or other materials of common application, but it is not convenient for the production of special tie bolts, i.e. made of material with high mechanical resistance (for example made of titanium alloy) given the difficulties of processing due to the type of material and the low quantities of tie bolts which are generally commissioned.

Alternatively, a tie bolt can be made by using a semi-automatic press, however also in this case the process is particularly expensive and slow. However also in this case there is the drawback of having to use equipment designed ad hoc different from the standard.

The problems indicated above increase when the tie bolt must be made of a material lighter than steel with high mechanical resistance, for example titanium and alloys thereof, due to the process specifications that these materials require.

### DISCLOSURE OF INVENTION

The object of the present invention is to provide a process for manufacturing a tie bolt, in particular made of highly performing material, which allows the drawbacks mentioned above to be overcome.

The object of the present invention is to provide an improved tie bolt which allows the drawbacks described above to be overcome.

According to the present invention, a process is provided for manufacturing tie bolts as mentioned in the appended claims.

According to the present invention, a tie bolt of the improved type is provided as mentioned in the appended claims.

### BRIEF DESCRIPTION OF THE DRAWINGS

The present invention will now be described with reference to the accompanying drawings, which illustrate some non-limiting embodiment examples, wherein:

FIG. 1 schematically shows a tie bolt according to the present invention;

FIG. 2 is an exploded view of FIG. 1;

FIG. 3 shows, in section and on an enlarged scale, the detail III of FIG. 1;

FIGS. 4 and 5 are schematic views and show respective different embodiments of a threaded tightening between a nut and a shank coupled to one another for forming a tie bolt according to the present invention; and,

FIG. 6 is a block diagram for illustrating schematically some steps of a process according to the present invention.

### BEST MODE FOR CARRYING OUT THE INVENTION

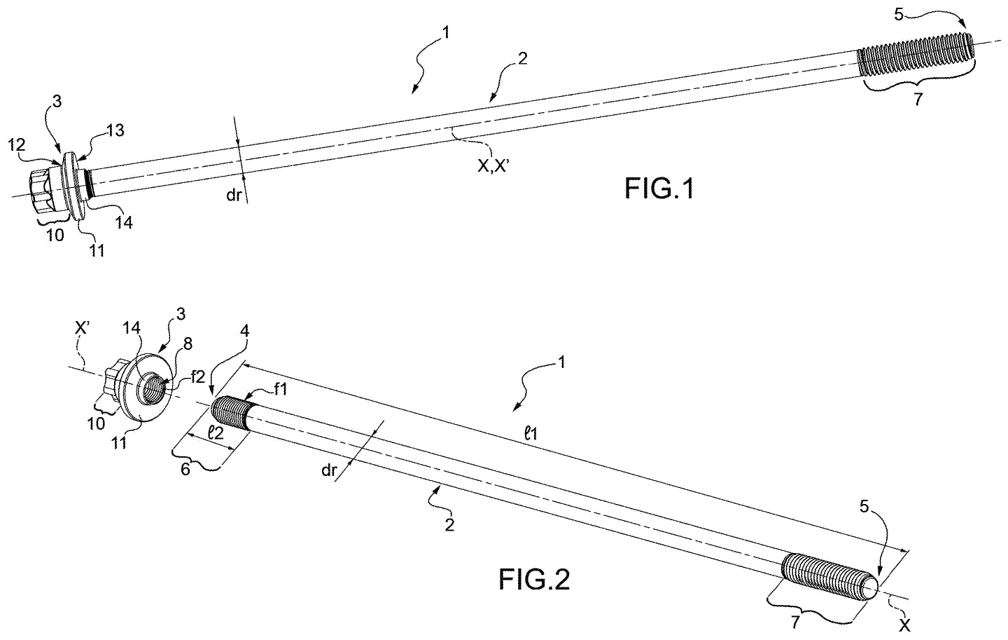

In FIG. 1, reference numeral 1 indicates as a whole a tie bolt 1 according to the present invention.

Advantageously, the tie bolt 1 is particularly suitable for tightening bodies subjected to high dynamic stresses, i.e. vibrations. For example, the tie bolt 1 is configured for tightening components of a vehicle engine or in a turbine engine. In other words, the tie bolt 1 according to the present invention can find application for example in the automotive and aerospace sector. The tie bolt 1 is configured for tightening components in extreme temperature and vibrational conditions.

Advantageously, the tie bolt 1 is configured for withstanding high temperatures, in particular temperatures higher than the melting point of steel, such as for example temperatures higher than 1300° C.

According to what illustrated in FIG. 2, the tie bolt 1 comprises a shank 2 and a nut 3, i.e. two distinct bodies, which are tightened and locked together, as better illustrated below, so as to form a single body. In other words, the tie bolt 1 according to the present invention is not made in a single monolithic piece.

Advantageously, the shank 2 is made of a material with high mechanical strength. Advantageously, the shank 2 is made of a material chosen within the following group of materials: titanium, titanium alloys; nickel-chrome alloys generally known as INCONEL®; X1CrNiMoAlTi12-11-2 stainless steel generally known as MLX17®; X1NiCrMoAlTi12-10-2 stainless steel generally known as MLX19®; and stainless steel with a PH (Precipitation Hardening) class ranging from 13 to 8 or from 15 to 5 or from 17 to 4; steel with composition Si, 19.00-21.00 Cr, 33.00-37.00 Ni, 9.00-11.00 Mo, 1.00 max. Ti, 0.01 B, 1.00 max Fe, Bal Co generally known as MP35N®; steel comprising nickel and cobalt generally known as MARAGING® and/or VASCOMAX®, for example MARAGING300 or AERMET®100; AISI4340 and AFNOR30NiCrMo16 steel, and stainless steel of the AISI300 series and of the AISI400 series.

Advantageously, the nut 3 is made of a material with high mechanical strength. Advantageously, the nut 3 is made of a material chosen within the following group of materials: titanium, titanium alloys; nickel-chrome alloys generally known as INCONEL®; X1CrNiMoAlTi12-11-2 stainless steel generally known as MLX17®; X1NiCrMoAlTi12-10-2 stainless steel generally known as MLX19®; and stainless steel with a PH (Precipitation Hardening) class ranging from 13 to 8 or from 15 to 5 or from 17 to 4; steel with composition Si, 19.00-21.00 Cr, 33.00-37.00 Ni, 9.00-11.00 Mo, 1.00 max. Ti, 0.01 B, 1.00 max Fe, Bal Co generally known as MP35N®; steel comprising nickel and cobalt generally known as MARAGING® and/or VASCOMAX®, for example MARAGING300 or AERMET®100; AISI4340 and AFNOR30NiCrMo16 steel and of the AISI300 series and of the AISI400 series.

According to an embodiment, the shank 2 and the nut 3 are made of the same material.

According to a further embodiment, the shank 2 and the nut 3 are made of different materials. In this case, advantageously, it is possible to choose the material of the shank 2 and of the nut 3 according to the specific application. For example, it is possible to choose the material of the shank 2 and of the nut 3 according to the coefficient of friction that is desired, in order to guarantee the desired fixing. Or, it is possible to select the material of the shank 2 and of the nut 3 so as to use a lighter material for a component less stressed during use, for example for the nut 3, so as to obtain a tie bolt 1 which is lightened as much as possible and which allows at the same time the full tightening capacity.

For example the nut 3 is made of aluminum, or an alloy thereof, and the shank 2 is made of titanium, or an alloy thereof, in this case advantageously: the tie bolt 1 has a reduced weight (aluminum has a density lower than the density of titanium); the locking between shank 2 and nut 3 is safer since the coefficient of friction for aluminum on titanium (>0.4) is generally higher than the coefficient of friction for titanium on titanium (>0.3); the shank 2 made of titanium guarantees the mechanical resistance of the tie bolt 1 to vibrations and high temperatures.

According to what shown in FIG. 4, the shank 2 is an at least partially cylindrical body having a longitudinal axis of rotation X. The shank 2 has a head end 4, which is configured for coupling with the nut 3, and a foot end 5 opposite the head end 4. The shank 2 has a length l1, i.e. an extension along the longitudinal axis X of at least 150 mm.

Preferably, for automotive applications, the shank 2 has a length l1 greater than 200 mm, generally about 300 mm. According to the illustrated example, the shank 2 is a cylindrical body having a constant outer diameter dr along the entire length l1 thereof. According to a variant not shown, the shank 2 can have some portions with a different diameter (greater or smaller) than the outer diameter dr at the head end 4 and/or the foot end 5.

According to a variant not shown, the shank 2 can have a section with a different shape, for example with a polygonal profile.

Advantageously, the head end 4 has a threaded head portion 6.

According to the illustrated example, the shank 2 has a further threaded portion 7. In the illustrated example, the further threaded portion 7 is made at the foot end 5, therefore hereinafter it is identified as foot portion 7. According to a variant not shown, the further threaded portion 7 is made in a different position, for example in an intermediate position, of the shank 2.

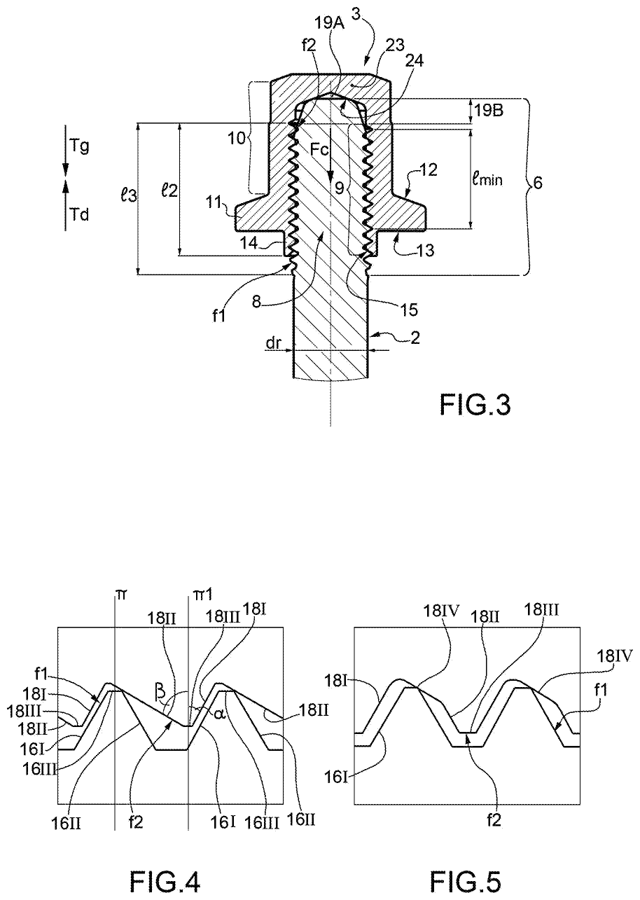

Advantageously, the nut 3 has a longitudinal axis of rotation X and a cavity 8 substantially coaxial with said longitudinal axis X (FIGS. 2 and 3). The cavity 8 has an internal threaded portion 9 (shown in FIG. 3).

Advantageously, the nut 3 and the shank 2 are configured so that the minimum length of the gripping thread is such that the yield strength Td of the nut 3 is substantially equal to the yield strength Tg of the shank 2.

The yield strength Td of the nut 3 is given by the following relationship:

$$T d = {σ}_{d} \frac{π}{4} {( 0 , 9 \times {∅}_{n d} )}^{\hat{}} 2$$

wherein:

σ_{d} is the yield stress of the material with which the nut 3 is made;

Ø_{nd} is the nominal diameter of the thread f2 of the nut 3.

The yield strength Tg of the shank 2 is given by the following relationship:

$$Tg = {σ}_{g} \frac{sin 30}{0 , 75 \times π \times {∅}_{n g} \times {l}_{min}}$$

wherein:

σ_{g} is the yield stress of the material with which the shank 2 is made;

Ø_{ng} is the nominal diameter of the thread f1 of the shank 2.

lₘᵢₙ is the minimum thread length f1 of the shank 2 gripping the nut 3.

It is known that the length of a thread is given by the following relationship:

l=p×n_{f}

wherein:

p is the pitch of the thread, which according to the known art is the longitudinal distance between two consecutive threads of the same helix;

n_{f} is the number of threads.

On the basis of the above formulas, once defined by the project, for example, the materials of the nut 3, of the shank 2 and the value of the nominal diameter Ø_{ng} it is possible to determine the minimum length of the thread f1 coupled with the thread f2 of the nut 3.

According to the illustrated example, the nut 3 has an operating portion 10, which is configured for being engaged, in use, by a tool (not shown) to rotate the nut 3 around the longitudinal axis of rotation X.

According to the illustrated example, the nut 3 has a flange 11 which protrudes radially outside the operating portion 10. The flange 11 is substantially a thin body and has a head surface 12, which faces the operating portion 10, and an opposed foot surface 13. According to the illustrated example, the nut 3 has a collar 14 which protrudes axially from the foot surface 13 of the flange 11 and is coaxial with the longitudinal axis X′. According to the illustrated example, the collar 14 has a diameter greater than the diameter dr of the corresponding shank 2. According to the illustrated example, the cavity 8 faces the outside of the nut 3 through an opening 15 made at the collar 14.

Advantageously, the collar 14 allows centering and align the shank 2 with the nut 3. According to the illustrated example, the collar 14 is threaded internally. According to a variant not shown, the collar 14 is not threaded.

According to a further variant, not shown, the collar 14 has a seat sized so as to obtain a coupling with the head portion 6 with a hole basis-shaft basis type of precision, so as to provide for the alignment of the shank 2 with respect to the nut 3.

According to a variant not shown, the nut 3 can be devoid of the collar 14.

In addition or as an alternative to the above, the alignment between shank 2 and nut 3 can be obtained by means of the flange 11, which in this case is made in such a way to have a seat sized so as to obtain a coupling with the head portion 6 with a hole basis-shaft basis type of precision.

As shown in FIGS. 2 and 3, the nut 3 is dead.

In other words, the cavity 8 is not through, i.e. it faces the outside through a single opening 15.

As shown in FIG. 3, the shank 2 is screwed into the cavity 8 so as to form the tie bolt 1.

As illustrated in detail in Figures from 3 to 5, the head portion 6 of the shank 2 has a thread f1 and the internal threaded portion 9 of the cavity 8 of the nut 3 has a thread f2.

The threads f1 and f2 are configured for coupling and tightening to one another. Advantageously, the threads f1 and f2 are self-locking. In other words, the thread f1 and the thread f2 are configured for generating, during the screwing between shank 2 and nut 3, a joint which opposes the unscrewing.

Advantageously, the cavity 8 has a housing 19A which is substantially, as shown in the figure, a bottom portion of the nut 3. Advantageously, the nut 3 is dead, i.e. it has a bottom wall 23 which is substantially transverse to the longitudinal axis X′ and closes the cavity 8 so that the nut 3 is substantially a cup-shaped body. Advantageously, the head portion 6 has an end portion 19B which protrudes axially from the thread f1. The end portion 19B is configured for fitting inside the housing 19A.

Advantageously, the end portion 19B is placed in contact, in use, against the bottom wall 23. In this way, it is possible to obtain a pre-load force Fc, as better illustrated below, which will allow fitting the thread f1 with the thread f2, guaranteeing the locking.

According to the illustrated example, the bottom wall 23 is delimited by a bottom surface 24 which faces the inside of the cavity 8. The bottom surface 24 is substantially conical and coaxial with the longitudinal axis.

Advantageously, the inclination of the bottom surface 24 with respect to the longitudinal axis allows adjusting the pre-load force according to the degree of screwing of the shank 2 inside the nut 3.

Advantageously, the inclination of the bottom surface 24 allows facilitating the alignment between the shank 2 and the nut 3.

The thread f1 and the thread f2 are chosen within a group comprising a plurality of pairs of self-locking profiles. FIGS. 4 and 5 show some examples of possible profiles of self-locking threads. It is noted that FIGS. 4 and 5, by way of example, show some known profiles of self-locking threads. According to some variants, not shown, the threads f1 and f2 can have different profiles.

According to the example shown in FIG. 4, the thread f1 has two sides, hereinafter identified with side 16I and 16II connected to one another by a head fitting 16III, which according to the illustrated example is flat. The sides 16I and 16II are substantially mirror-like to each other, i.e. they have an equal and opposite inclination with respect to a plane π (illustrated with a dashed line in FIG. 4) perpendicular to the longitudinal axis X.

Furthermore, the longitudinal extension of the sides 16I and 16II is substantially the same.

Whereas, the thread f2 is asymmetrical, i.e. the thread f2 has two sides, hereinafter identified with 18I and 18II, connected to oner another by a head fitting 18III, which according to the illustrated example is flat. The sides 18I and 18II have different inclinations with respect to a plane π1 (illustrated with a dotted line in FIG. 4) perpendicular to the longitudinal axis X′. Furthermore, the sides 18I and 18II have different longitudinal extensions. In more detail, the side 18I forms an angle α with the plane π1, while the side 18II forms an angle β with the plane π1. In particular, the angle α is smaller than the angle β.

FIG. 5 shows a variant of a combination of the threads f1 and f2. According to the example illustrated in FIG. 5, the thread f2 has a further fitting portion 18IV, which connects the side 18II with the adjacent side 18I. The portion 18IV is inclined with respect to the respective portion 18I and is configured for coming into contact and creating a shoulder, during use, for the thread f1.

In the examples illustrated in FIGS. 4 and 5, the thread f1 (male) is symmetrical and the thread f2 (female) is asymmetrical. According to a variant not shown, the thread f1 (male) is asymmetrical and the thread f2 (female) is symmetrical.

Advantageously, by providing threads f1 and f2 with self-locking profiles, once tightened on the shank 2, the nut 3 is indissolubly fixed to the shank 2 itself and forms a tie bolt 1, which behaves like a tie bolt 1 of known type manufactured in one piece.

Advantageously, the fact that the nut 3 is dead, i.e. it has the bottom wall 23, allows obtaining a pre-load force Fc between nut 3 and shank 2, which in particular acts on the threads f1 and f2 locking them to one another. The pre-load force Fc is the force resistant to the thrust exerted by the end portion 19B on the bottom wall 23 following the insertion and screwing of the head portion 6 inside the cavity 8.

According to a variant not shown, the thread f1 and the thread f2 can have normal profiles, i.e not self-locking. In this case, the shank 2 and the nut 3 are fixed to one another by interference. In particular, exploiting a hot/cold connection, as better illustrated below.

Advantageously, the fact that the shank 2 and the nut 3 are both made of titanium alloy increases the locking effect between nut 3 and shank 2. In fact, titanium has a static and dry coefficient of friction >0.3 (for example the static and dry coefficient of friction for Titanium Alloy Ti-6Al-4V (Grade 5) on Titanium Alloy Ti-6Al-4V (Grade 5) is about 0.36) this allows obtaining a particularly firm and resistant locking between the nut 3 and the shank 2. In other words, the fact that the nut 3 and the shank 2 are made of a titanium alloy increases the safety of the fixing of the components to one another.

Advantageously, the fact that the shank 2 and the nut 3 are made of different materials can allow increasing the locking effect between the two. For example, if the shank 2 is made of titanium and the nut 3 is made of aluminum, this allows obtaining a static and dry coefficient of friction >0.4 (for example the static and dry coefficient of friction for Titanium Alloy Ti-6Al-4V (Grade 5) on Aluminum Alloy 6061-T6 is approximately 0.41).

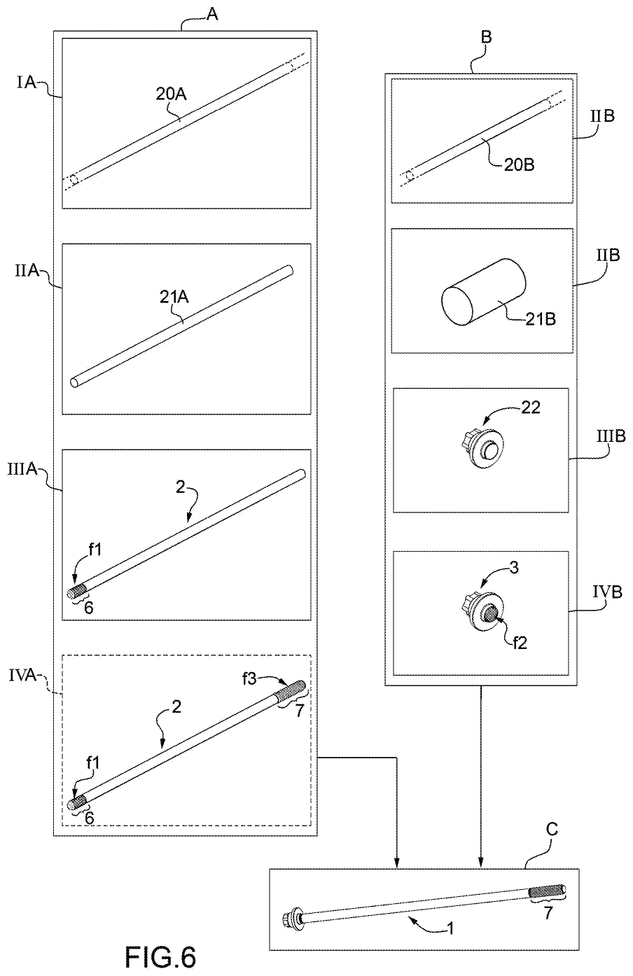

A process for manufacturing a tie bolt 1 according to the present invention is described here below, referring also to the block diagram illustrated in FIG. 6.

The process involves a step of arranging a shank 2 (schematized with the block A) and a step of arranging a nut 3 (schematized with the block B). The process also involves a step of tightening, locking, the nut 3 to a threaded head portion 6 of the shank 2 (schematized with the block C).

The step of arranging a shank 2 and the step of arranging a nut 3 can be performed both simultaneously and in succession.

The step of arranging a shank 2 involves the sub-steps of:
arranging a bar 20A of metallic material, in particular a high resistance metal (sub-block IA), advantageously the bar 20A is calibrated;
obtaining, in particular by cutting, from the bar 20A a shank 21A with a predetermined length l1 (sub-block IIA), advantageously, the length l1 substantially corresponding to the length of the final shank 2; and
making a thread f1 along the head portion 6 for obtaining the shank 2 (sub-block IIIA).

The step of arranging a nut 3 comprises the sub-steps of:
arranging a bar 20B or wire (variant not shown) of metallic material, in particular a metal with high resistance (sub-block IB);
obtaining, in particular by cutting, a shank 21B with a predetermined length (sub-block IIB); and
forging the shank 21B, in particular by means of an automatic molding machine, so as to obtain a semi-finished product 22 substantially with the external shape of the nut 3 and having a cavity 8 (sub-block IIIB), advantageously the nut 3 is dead and has a bottom wall 23;
making a thread f2 inside the cavity 8 for completing the construction of the nut 3 (sub-block IVB).

As previously mentioned, the manufacturing process also involves the tightening of the nut 3 on the shank 2. The tightening step can simply comprise the sub-step of screwing the nut 3 onto the head portion 6. In this case, the locking of the nut 3 on the portion 6 of the shank 2 is given by the interaction of the self-locking threads f1 and f2.

Advantageously, during the tightening step, the threads f1 and f2 are screwed so as to bring the bottom portion 19B into contact with the bottom surface 24 of the nut 3. Advantageously, during the tightening step, the threads f1 and f2 are screwed to one another so as to push the bottom portion 19B against the bottom surface 24, so as to generate a pre-load force Fc which acts on the shank 2 and ensures the tightening between the shank 2 and the nut 3. The pre-load force Fc is basically a function of the screwing level between the thread f1 and the thread f2.

Advantageously, the pre-load force Fc generated on the shank 2 is given by the inclination of the bottom surface 24 with respect to the longitudinal axis X′ of the nut 3 (and consequently of the shank 2).

Optionally, the tightening step can involve a heat treatment step of the nut 3 and/or the shank 2. For example, the tightening step can involve heating the nut 3, so as to perform a coupling by hot/cold interference.

Optionally, according to the example shown in FIG. 6, a further threaded portion 7 is realized on the shank 2 having a thread f3 (dashed IVA sub-block). According to the illustrated example, the further thread f3 is made along a foot portion 7.

According to a variant not shown, the thread f3 can be made after the step of tightening the nut 3 on the shank 2.

Advantageously, both the thread f1 and the thread f3 are made by rolling. Advantageously the nut 3 and the shank 2 are made of the same material and this for tribological attributes facilitates the locking by seizing, i.e. welding, of the thread f1 on the thread f2 by chemical affinities, especially with the titanium-based alloys.

In the illustrated examples, the thread f1 and the thread f2 are at a beginning.

The process of the type described above is simple and quick to implement and allows the use of machinery generally already in use by manufacturers of tightening components, such as screw manufacturers.

Advantageously, a tie bolt 1 of the type described above is made with significantly reduced costs and production time, compared to the tie bolts in a single piece and of a known type.

Advantageously, the tie bolt 1 of the type described above has a high fatigue resistance, in particular in the junction area between the shank 2 and the nut 3. Therefore, advantageously, a tie bolt 1 of the type described above can be used in environments highly stressed to vibrations, such as for example the engine base of a vehicle.

The tie bolt 1 of the type described above is resistant to high temperatures.

Advantageously, a tie bolt 1 of the type described above guarantees the same reliability and the same tightening properties of a monolithic tie bolt 1 of a known type.

Advantageously, the fact that the shank 2 and the nut 3 are made of different materials (for example shank 2 made of titanium alloy and nut 3 made of aluminum alloy) allows obtaining a tie bolt 1 which guarantees high performance and, at the same time, is lightened.

1. A process for manufacturing a tie bolt comprising the steps of:
providing a shank having a longitudinal axis; said shank having a head end and a foot end; wherein said shank has a first thread made along a first portion, in particular in the area of the head end;
providing a nut, in particular a dead nut, having a cavity facing outwards from an opening of said nut; said nut having a second thread made inside said cavity;
tightening said nut against the head end of said shank, so as to screw said second thread around said first thread;
wherein said tightening step involves fitting said nut around said first portion of the shank to form a single, indivisible, body.

2. A process according to claim 1, wherein the step of providing the shank and the step of providing the nut can take place simultaneously or at least partially in succession; wherein, the shank and the nut are made of a high mechanical resistance material; in particular, the shank and/or the nut are made of a material chosen within the following group of materials: titanium, titanium alloys; nickel-chrome alloys; X1CrNiMoAlTi12-11-2 stainless steel; X1NiCrMoAlTi12-10-2 stainless steel; and stainless steel with a PH (Precipitation Hardening) class ranging from 13 to 8 or from 15 to 5 or from 17 to 4; steel with composition Si, 19.00-21.00 Cr, 33.00-37.00 Ni, 9.00-11.00 Mo, 1.00 max. Ti, 0.01 B, 1.00 max. Fe, Bal Co; steel comprising nickel and cobalt; AISI4340 and AISI304 steel and stainless steel of the AISI300 series and of the AISI400 series.

3. A process according to claim 1, wherein the step of providing a shank comprises the sub-step of making said first thread along said first portion; wherein the step of providing a nut comprises a sub-step of making said second thread inside said cavity.

4. A process according to claim 3, wherein the first thread of said shank and the second thread of said nut have profiles which are configured to form a self-locking tightening; wherein said nut has a bottom wall delimited by a bottom surface and said first portion has an end portion; wherein said tightening step involves screwing said first thread of said shank and said second thread of said nut to one another so as to cause said end portion to strike against said bottom surface and generate, upon said shank, a predefined pre-load force as a function of the level of screwing of the shank with the nut.

5. A process according to claim 1, wherein the tightening step involves locking the nut and the shank to one another by means of an interference coupling, in particular a hot/cold coupling.

6. A process according to claim 1 and comprising the further step of making a third thread along a respective further portion of said shank.

7. A tie bolt comprising a shank having a longitudinal axis; said shank having a head end and a foot end; wherein said shank has a first thread made along a first portion, in particular in the area of the head end; said tie bolt comprising a nut, in particular a dead nut, having a cavity facing outwards from an opening of said nut; said nut having a second thread realized inside said cavity; wherein said nut is tightened and locked around said first end to form an indivisible body.

8. A tie bolt according to claim 7, wherein the first thread and the second thread have profiles which are configured to form a self-locking tightening.

9. A tie bolt according to claim 7, wherein the shank and the nut are fixed to one another by means of an interference coupling, in particular a hot/cold coupling.

10. A tie bolt according to claim 7, wherein the shank and the nut are made of a material chosen within the following group of materials: titanium, titanium alloys; nickel-chrome alloys; X1CrNiMoAlTi12-11-2 stainless steel; X1NiCrMoAlTi12-10-2 stainless steel; and stainless steel with a PH (Precipitation Hardening) class ranging from 13 to 8 or from 15 to 5 or from 17 to 4; steel with composition Si, 19.00-21.00 Cr, 33.00-37.00 Ni, 9.00-11.00 Mo, 1.00 max. Ti, 0.01 B, 1.00 max. Fe, Bal Co; steel comprising nickel and cobalt; AISI4340 and AISI304 steel and stainless steel of the AISI300 series and of the AISI400 series.

11. A tie bolt according to claim 7 and having a length, namely an extension along said longitudinal axis, greater than 160 mm.

12. A tie bolt according to claim 7, wherein said nut has a bottom wall and a bottom surface facing a housing, wherein said shank has an end portion, which is configured to be inserted into said housing and to come into contact with said bottom surface; wherein said bottom surface is at least partially inclined relative to said longitudinal axis, in particular said bottom surface is conical.
